(19) United States
(12) Patent Application Publication
(10) Pub. No.: US 2023/0264407 A1
(43) Pub. Date: Aug. 24, 2023

(54) FILTER UNIT FOR AN EXTRUDER ASSEMBLY, FILTER ARRANGEMENT AND CORRESPONDING FILTER CHANGING DEVICE AND METHOD FOR PRODUCING SUCH A FILTER UNIT

(71) Applicant: Coperion GmbH, Stuttgart (DE)

(72) Inventors: Stefan HUBER, Leonberg (DE); Tomi TRATNIK, Ditzingen (DE); Markus SCHMUDDE, Steinheim a.d. Murr (DE); Carsten KOBERG, Steinheim a.d. Murr (DE); Ralf KÜHN, Erligheim (DE); Manuel GRAUPE, Stuttgart (DE)

(73) Assignee: Coperion GmbH, Stuttgart (DE)

(21) Appl. No.: 18/172,558

(22) Filed: Feb. 22, 2023

(30) Foreign Application Priority Data
Feb. 24, 2022 (EP) 22 158 674.6

(51) Int. Cl. B29C 48/691; B01D 29/00; B01D 29/23; B01D 29/54; B01D 29/90; B01D 29/96; B01D 29/11

(52) U.S. Cl. CPC B29C 48/6912; B01D 29/0093; B01D 29/111; B01D 29/23; B01D 29/54; B01D 29/902; B01D 29/96; B01D 2201/043; B01D 2201/282; B01D 2201/44

(57) ABSTRACT

A filter unit for an extruder assembly comprises a support body with a hollow cylindrical wall section and a base section connected thereto, wherein the support body has a central longitudinal axis and delimits an inner space, wherein the hollow cylindrical wall section has a plurality of through openings opening into the inner space and forms an outlet opening for a molten plastic opposite the base section; and a displacement element for displacing the molten plastic which has entered the inner space, in particular via the through openings, substantially in the direction of the central longitudinal axis, wherein the displacement element and the support body are configured and/or produced in one piece, as well as filter arrangement with a plurality of such filter units, filter changing device with at least two filter arrangements and method for producing such a filter unit.

### CROSS-REFERENCE TO RELATED APPLICATION

This application claims the priority of European Patent Application, Serial No. EP 22 158 674.6, filed on Feb. 24, 2022, the content of which is incorporated herein by reference in its entirety as if fully set forth herein.

### DESCRIPTION

This disclosure relates to a filter unit for an extruder assembly. The disclosure additionally relates to a filter arrangement and a corresponding filter changing device for an extruder assembly. The disclosure further relates to a method for producing such a filter unit.

Typically, a molten plastic, in particular in the polyolefin range, is passed through a sieve changer, after the processing section or extrusion, in order to filter out foreign particles in advance of pelletizing. In the sieve changer, filter arrangements are used with a filter element holding plate and a plurality of support cages with filter elements.

For example, a filter device for extruders is known from document DE 2 119 545, which comprises elongated sieves and a holding plate for the sieves provided with bores which is arranged perpendicular to the flow direction of the molten plastic. The sieves have the form of a hollow cylinder open at one end and consist of an outer support cage made of wire, which has a flange at its open end for mounting in the holding plate, and of an inner sieve cage made of filter fabric, which in turn is provided with a flange for mounting in the support cage.

However, the known support cages have the disadvantage that, on the one hand, they exhibit high pressure loss and, on the other hand, they have a low degree of stability or insufficient strength during operation. Particularly when moving or replacing the support cages, the latter are subjected to high bending loads due to the low wall thicknesses. This can lead to the bending or even to the breakage of the support cage. Furthermore, the known filter units cause a considerable drop in pressure or differential pressure of the molten plastic, whereby the throughput of the molten plastic is limited by the filter arrangement. In addition, deposits can form on the inside of the support cages, which has a negative effect on the flow of the molten plastic. Furthermore, the cleaning of the current support cages, for example by pyrolysis, is very time-consuming and there is a risk that the separate components may become distorted or even detached during later operation.

The underlying object of embodiments of the disclosure is to structurally and/or functionally improve a filter unit of the aforementioned type. The object of embodiments of the disclosure is also to structurally and/or functionally improve a filter arrangement of the aforementioned type and a corresponding filter changing device. Furthermore, the object of embodiments of the disclosure is to functionally improve an aforementioned method for producing such a filter unit.

In particular, an object of embodiments of the present disclosure is to provide a filter unit, filter arrangement and filter changing device, which can reduce or eliminate the problems that have been identified in connection with the prior art.

The object is achieved by a filter unit having the features of claim 1. In addition, the object is achieved by a filter arrangement having the features of claim 11 and by a filter changing device having the features of claim 12. Furthermore, the object is achieved by a method having the features of claim 13. Advantageous embodiments and/or developments are the subject-matter of the subclaims.

A filter unit can be or can be configured for an extruder assembly and/or filter arrangement and/or filter changing device. The filter unit can be configured and/or intended for filtering a molten plastic.

The filter unit can have a support body. The support body can comprise a wall section in the form of a hollow cylinder. The support body can have a base section. The base section can be joined to the wall section. The support body can have and/or define a central longitudinal axis. The central longitudinal axis can be an axis of symmetry, in particular of the support body. The central longitudinal axis can extend in longitudinal direction of the support body. The support body can be rotationally symmetrical, in particular about its central longitudinal axis. The support body can delimit an inner space. The wall section and/or the base section can delimit the inner space. The hollow-cylindrical wall section can have a plurality of through openings which open into the inner space. The through openings can extend in radial direction relative to the central longitudinal axis. The through openings can be distributed evenly around the circumference of the support body or its wall section. The through openings of the wall section opening into the inner space can all have the same diameter. The diameter of the through openings can be between 2 and 5 mm, in particular between 3 and 4 mm, for example 3.5 mm. The through openings of the wall section can have different diameters. The wall section can form an outlet opening for the molten plastic, in particular opposite the base section. The base section can be arranged on the upstream side of the support body. The outlet opening can be arranged on the downstream side of the support body. The support body can be formed as a hollow cylinder open at one end. The wall section and the base section can be formed and/or produced in one piece and/or one part, i.e. from one piece or one part.

The filter unit can comprise a displacement element for displacing the molten plastic that has entered the inner space, in particular via the through openings, in particular substantially in the direction of the central longitudinal axis. The displacement element can be a displacer body or displacing body. The displacement element can be a displacer section or displacing section. The displacement element and the support body can be configured and/or produced in one part and/or one piece, i.e. from one piece or one part.

The displacement element can be arranged or formed in the inner space and/or on the base section. The displacement element and the base section can be formed and/or produced in one part and/or one piece, i.e. from one piece or one part. The displacement element can be arranged on the upstream side of the support body. The displacement element can be arranged on the side of the base section facing the inner space. The displacement element can extend from the base section into the inner space. The displacement element can have a base surface. The base surface can be the base section and/or be defined by the base section. The displacement element can be arranged or configured to be concentric to the central longitudinal axis. The displacement element can taper from the base section in the direction of the inner space and/or towards the central longitudinal axis.

The displacement element can be configured to be substantially conical and/or cone-shaped at least in sections. The displacement element can be configured to be substantially partly conical at least in sections. The displacement element can be configured to be substantially spherical or partially spherical at least in sections. The base surface of the displacement element can be formed and/or defined by the base section. The displacement element can be configured to be substantially conical, cone-shaped or frustroconical. The displacement element can be configured to be substantially hemispherical.

The displacement element can have a surface and/or contour, such as a casing surface and/or casing contour. The surface and/or contour can have one or more surface sections and/or contour sections, such as casing surface sections and/or casing contour sections. The one or plurality of surface sections or contour sections can taper in the direction of the central longitudinal axis, for example conically. The one or plurality of surface sections or contour sections can extend and/or be oriented in the direction of the central longitudinal axis at an angle oblique and/or relative to the central longitudinal axis. The angle can be a cone angle or half cone angle. The surface and/or contour or the one or plurality of surface sections or contour sections can be configured to be concentric to the central longitudinal axis. The surface and/or contour or the one or the plurality of surface sections or contour sections can have or define a plurality of diameters, which decrease in particular in axial direction, i.e. in the direction of the central longitudinal axis. The plurality of surface sections or contour sections can extend and/or be oriented at different angles obliquely and/or relative to the central longitudinal axis. The angle of a radially outer surface section or contour section can be greater than the angle of a radially inner surface section or contour section. The angle of the plurality of surface sections or contour sections can decrease in axial direction, i.e. in the direction of the central longitudinal axis. By varying the angle the flow of plastic or the flow behaviour of the molten plastic and/or the rheological conditions can be influenced as desired. The angle or angles can be between about 30° and 90° relative to the central longitudinal axis, in particular between about 50° and 88°, for example about 50.7°, 63° or 87°.

The support body and the displacement element can be produced from a substantially non-weldable steel, for example alloy steel, such as high-alloy steel, such as hot-work steel. The steel can be a steel of high strength and/or high toughness and/or high heat resistance. For example the steel can be a 1.23xx material.

The through openings can be through bores. The support body and/or its hollow cylindrical wall section can have or define an active filter area. The active filter area can be the total area of all through openings or all cross-sectional areas of the through openings. The active filter area can be the multiplication of the number of through openings with the cross-sectional area of a through opening. The through openings can all have the same bore cross-sectional area. The support body and/or its hollow cylindrical wall section can have or define an, in particular outer, casing surface. The through openings can be distributed over the casing surface, for example in several rows around the casing surface. The through openings can be arranged distributed evenly over the casing surface. The casing surface can be defined by the diameter, in particular outer diameter, of the support body and/or its hollow cylindrical wall section. The casing surface can be defined by the length, in particular in the direction of the central longitudinal axis, of the support body and/or its hollow cylindrical wall section. The ratio of the active filter area to the casing surface of the support body, in particular the wall section of the support body, can be about 0.15 to 0.65, in particular about 0.25 to 0.5, in particular about 0.38.

The support body and/or its hollow cylindrical wall section can have or define a wall thickness or wall strength, for example measured in radial direction. The wall thickness can be for example about 2 mm to 4 mm, in particular about 3 mm or 3.5 mm. The ratio of the diameter, in particular outer diameter, of the support body and/or its hollow cylindrical wall section squared to the length, in particular in the direction of the central longitudinal axis, of the support body and/or its hollow cylindrical wall section can be about 5 to 20, in particular about 10 to 16, for example about 10.7 or 15.5. The diameter, in particular outer diameter, of the support body and/or its hollow cylindrical wall section can be between about 40 mm to 70 mm, in particular about 50 mm or 60 mm. The length of the support body and/or its hollow cylindrical wall section can be between about 200 mm to 300 mm, in particular between about 200 mm and 250 mm, for example about 230 mm. The ratio of the wall thickness of the support body, in particular the wall section of the support body, to the ratio of diameter, such as outer diameter, of the support body, in particular of the wall section of the support body, squared to length, in particular in the direction of the central longitudinal axis, of the support body, in particular of the wall section of the support body, can be about 0.1 to 0.6, in particular about 0.2 to 0.3, in particular about 0.25.

The support body can further comprise a holding section. The holding section can be configured for attaching the filter unit to a filter support. The holding section can be formed on the downstream side of the support body. The holding section can have a thread, such as an external thread, or at least one detent element, such as a detent lug. The filter unit can comprise a cover element. The filter unit can comprise at least one filter element. The cover element can be configured to hold and/or fix the at least one filter element on the support body. The cover element can be securely connected to the support body, for example in a detachable manner, in particular screwed, for example to the base section and/or displacement element. The cover element can be configured to grip around the wall section or its casing surface. The cover element can have a diameter, such as inner diameter, which is greater than the diameter, in particular outer diameter, of the support body or its wall section. The at least one filter element can be arranged around the support body, in particular around the wall section or its casing surface, for example pushed on or wrapped around it. The filter element can be filter fleece or filter fabric. The filter element can be a grid, sieve or mesh. The filter element can comprise a plurality of filter fleeces, filter fabrics, grids and/or screens, which can be arranged for example on top of one another or behind one another in radial direction. The grids and/or sieves can have the same or different grid sizes and/or grid widths and/or grid holes. The grids and/or sieves can be made of metal and/or plastic. The filter fleeces or filter fabrics can be made of fibres, such as plastic fibres, glass fibres, carbon fibres, natural fibres or a mixture thereof.

A filter arrangement can be or can be configured for an extruder assembly and/or filer changing device. The filter arrangement can comprise a filter support. The filter support can be circular in cross-section. The filter support can be substantially disc-like. The filter support can have a support central longitudinal axis. The support central longitudinal axis can extend in the conveying direction. The filter support can have a plurality of support through openings extending in particular in the direction of the support central longitudinal axis. A first support through opening can be arranged concentrically to the support central longitudinal axis. A group of for example six second support through openings can be arranged along a first circle. The first circle can be arranged concentrically to the support central longitudinal axis. The second support through openings can be arranged distributed evenly along the first circle. A further group of, for example twelve, third support through openings can be arranged along a second circle. The second circle can be arranged concentrically to the support central longitudinal axis. The second circle can surround the first circle. The third support through openings can be arranged distributed evenly along the second circle.

The filter arrangement can comprise at least one, in particular a plurality of filter units. In the region of each of the support through openings a filter unit can be attached and/or can be attachable respectively in a detachable manner to the filter support. The support through openings can each have a holding section which is configured to be complementary to the holding section of the filter units. The holding sections of the support through openings can each have a thread, such as an internal thread, which is configured to be complementary to the thread, such as external thread of the filter units. The holding sections of the support through openings can each have a structure for securing the filter unit which is complementary to the detent element, such as the detent lug, of the filter unit. The filter units can be arranged upstream of the filter support in conveying direction. The filter units can all be configured to be identical. The filter units can be configured as described above and/or in the following.

A filter changing device can be for or can be configured for an extruder assembly. The filter changing device can comprise a housing and at least one melt channel extending in the housing. For example, the filter changing device can have two melt channels extending in the housing, each of which opens into or passes into a common channel at the upstream melt inlet and at the downstream melt outlet. The at least one melt channel is configured for guiding the molten plastic produced in an extruder.

The filter changing device can comprise at least one guide bore extending transversely to the at least one melt channel and through the latter in the housing. The at least one guide bore can extend transversely, for example substantially perpendicular, to the conveying direction and/or traverse the at least one melt channel. The filter changing device can comprise at least one slide element arranged in the at least one guide bore. The at least one slide element can be configured to be plate-like or cylindrical. The filter changing device can have at least one actuating drive. The at least one slide element can be displaced by the at least one actuating drive transversely, for example substantially perpendicularly, to the conveying direction and/or transversely, for example substantially perpendicularly, to at least one melt channel. The at least one actuating drive can be configured to be hydraulic and/or electromechanical for example.

The filter changing device can have at least two filter arrangements arranged and/or mounted spaced apart on the at least one slide element, for example in a replaceable manner. The filter arrangements can be configured as described above and/or in the following. Two continuous receiving openings can be formed in the at least one slide element. A filter arrangement can be mounted and/or secured in a replaceable manner in the two receiving openings respectively. The two receiving openings can be spaced apart transversely, for example substantially perpendicularly, to the conveying direction and/or transversely, for example substantially perpendicularly, to the at least one melt channel, such that one of the respective filter arrangements is located outside the housing when the other respective filter arrangement is located in the melt channel.

An extruder assembly can comprise a filter changing device. The filter changing device can be configured as described above and/or in the following. The extruder assemply can comprise an extruder, for example a twin-screw extruder. The filter changing device can be arranged downstream of the extruder in the conveying direction. The extruder assembly can comprise a pelletizer. The pelletizer can be configured and/or intended for pelletizing plastic material strands. The filer changing device can be arranged upstream of the pelletizer in the conveying direction.

A method can be for and/or can be used for the production of a filter unit. The method can be for and/or can be used for producing the filter unit described above and/or in the following.

The method can comprise the step of producing a blind hole in an, in particular cylindrical, steel blank, for example a substantially non-weldable steel blank. The blind hole can be produced by drilling and/or milling and/or eroding and/or turning and/or another manufacturing process. The producing of the blind hole can also be understood as the manufacture of the blind hole. The production, for example the drilling and/or milling, of the blind hole can be performed along the central longitudinal axis. The drilling and/or milling of the blind hole can consist of pre-drilling and/or pre-milling. The eroding or turning can consist of pre-eroding or pre-turning.

The method can comprise the step of producing a displacement element inside the blind hole, in particular on or in the blind hole bottom or blind hole base. The production of the displacement element can be performed by drilling and/or milling and/or eroding and/or turning and/or other manufacturing method. The production of the displacement element can also be understood as the manufacture of the displacement element. The production of the blind hole and the displacement element can be performed in one step or in consecutive steps. The drilling and/or milling can be performed in one process.

The method can comprise the step of enlarging the blind hole, in particular enlarging by machining. The blind hole can be enlarged by reaming, i.e. reaming out, and/or drilling and/or turning. The reaming can be performed by a reamer for example. The drilling and/or turning can be performed by a drilling rod for example. The turning can be performed by a turning tool for example. The enlarging, in particular reaming and/or drilling and/or turning, can be performed with vibration damping. Vibrations from the reamer and/or the drilling rod and/or the turning tool can be damped. Enlarging the blind hole can include and/or consist of adjusting and/or improving, for example the roughness and/or quality of the surface. Enlarging the blind hole can be performed before and/or after the production of the displacement element. The reaming and/or drilling and/or turning can be performed in one process. The blind hole can be flushed out before the enlargement.

The production, for example the drilling and/or milling, of the displacement element can be performed by means of a drilling rod. The drilling rod can comprise a conical drill or be configured in such a way. The drilling rod can comprise at least one cutting plate, such as an indexable insert. The drilling rod can have 1 to 10, for example 2 to 7, in particular 3 to 5 cutting plates. There can be an even or odd number of cutting plates. The at least one cutting plate or indexable insert can have a substantially square and/or round shape, for example a substantially square, rectangular and/or triangular shape. The drilling rod or the conical drill can have a geometry at one end which is dependent on the surface and/or contour of the displacement element, for example a geometry which is substantially complementary to the displacement element. The at least one cutting plate can have a geometry which is dependent on the surface and/or contour of the displacement element. The drilling rod can have a number of cutting plates, such as indexable inserts. The number of cutting plates can be dependent on the surface and/or contour of the displacement element. The number of cutting plates can be equal to or twice the number of surface sections or contour sections of the displacement element. The number of cutting plates can amount to and/or be 1 to 10, for example 2 to 7, in particular 3 to 5 cutting plates. The cutting plates can have and/or define the angle of the surface sections or contour sections.

In embodiments, the loss in pressure can be reduced significantly. The throughput can be increased. The stability and/or strength of the support body can be improved, in particular during operation. The support body or its wall section can have a thinner wall thickness compared to known support bodies. Deposits on the inside can be avoided and the cleaning can be simplified. The processing reliability of the production method can be improved. The evacuation of chippings and/or the processing time can be improved.

Exemplary embodiments of the disclosure are described in more detail in the following with reference to the Figures, which show in schematic form and by way of example:

FIG. 1 a side view of a filter unit;

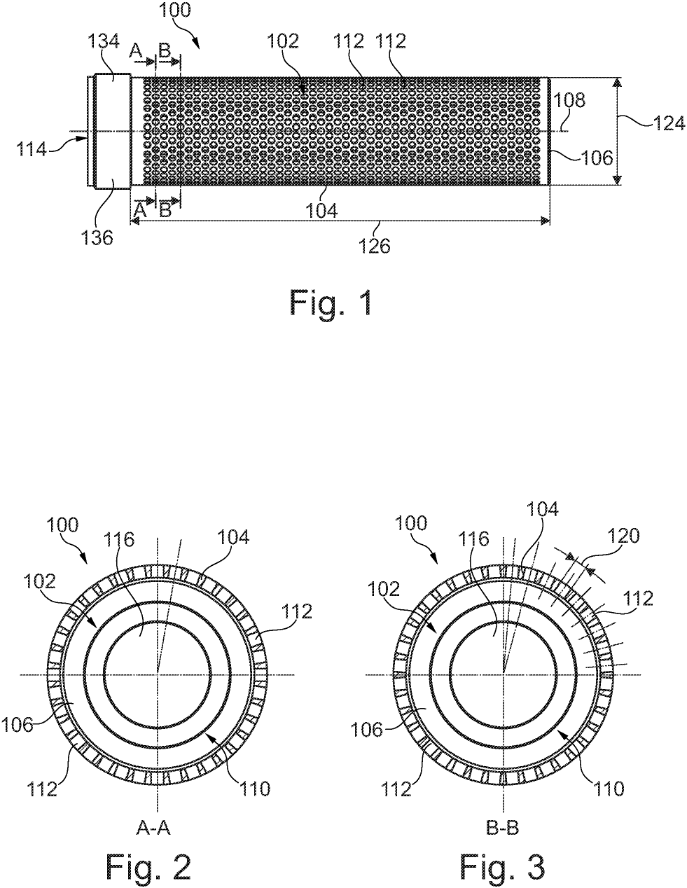

FIG. 2 a sectional view along A-A of the filter unit according to FIG. 1;

FIG. 3 a sectional view along B-B of the filter unit according to FIG. 1;

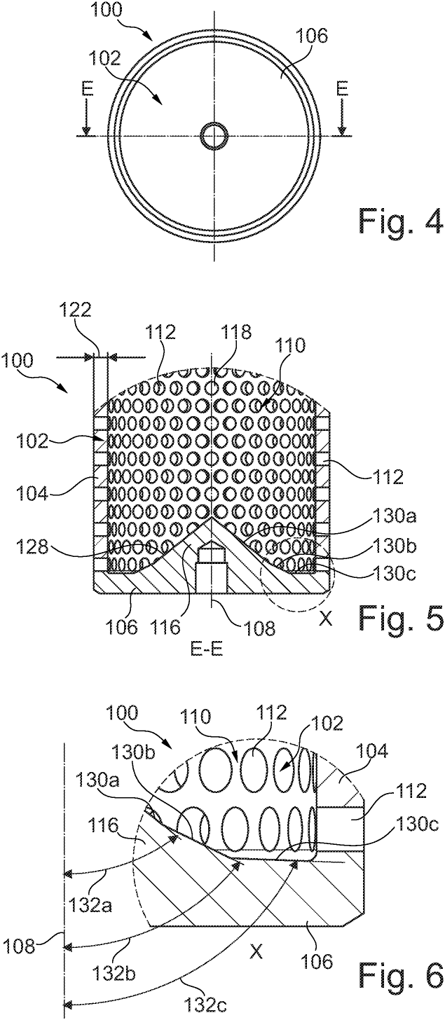

FIG. 4 a front view of the filter unit according to FIG. 1;

FIG. 5 a partial sectional view along E-E of the filter unit according to FIGS. 1 and 4;

FIG. 6 a detailed view X of the filter unit according to FIGS. 1 and 5;

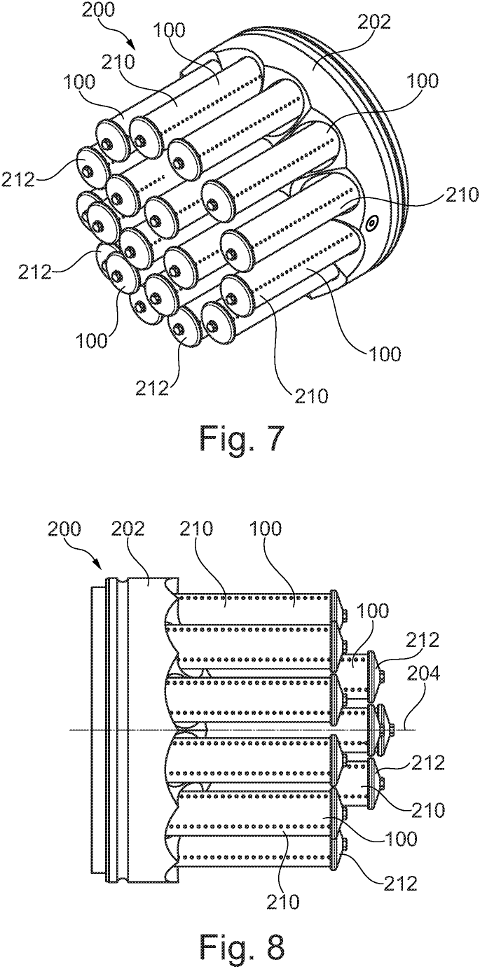

FIG. 7 a perspective view of a filter arrangement;

FIG. 8 a side view of the filter arrangement according to FIG. 7;

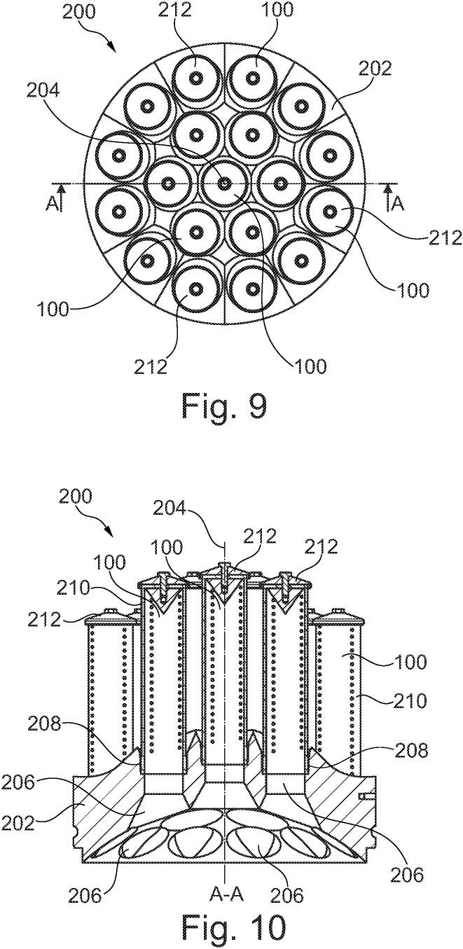

FIG. 9 a front view of the filter arrangement according to FIG. 7;

FIG. 10 a sectional view along A-A of the filter arrangement according to FIGS. 7 and 9;

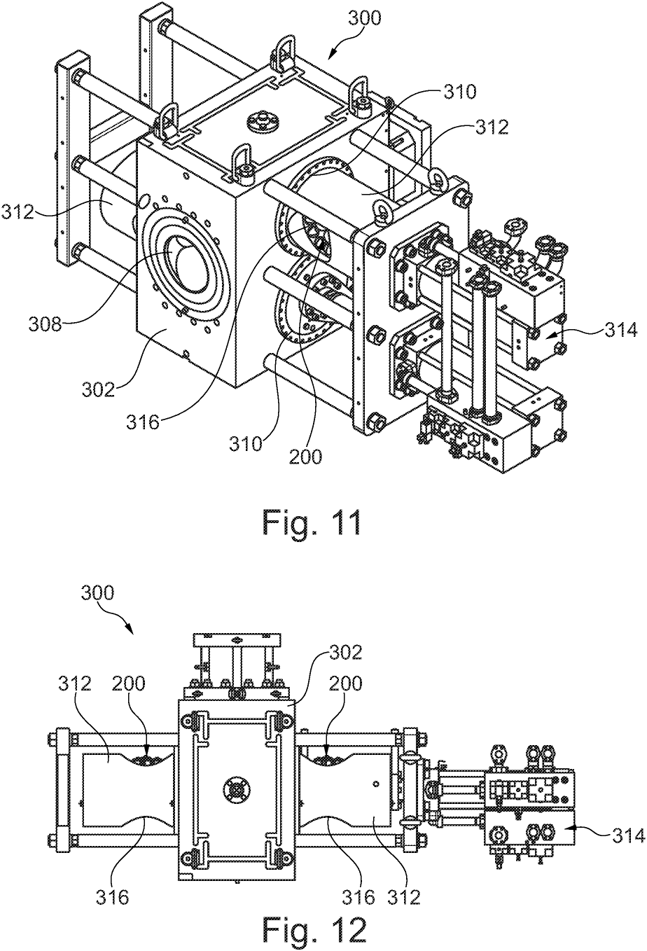

FIG. 11 a perspective view of a filter changing device;

FIG. 12 a plan view of the filter changing device according to FIG. 11;

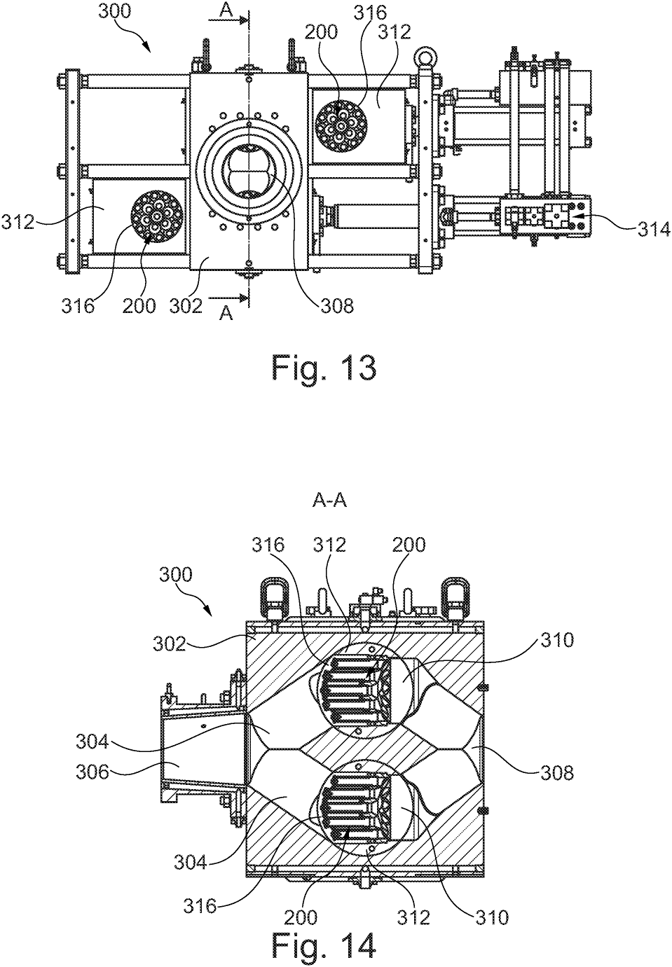

FIG. 13 a rear view of the filter changing device according to FIG. 11;

FIG. 14 a sectional view along A-A of the filter changing device according to FIGS. 11 and 13; and

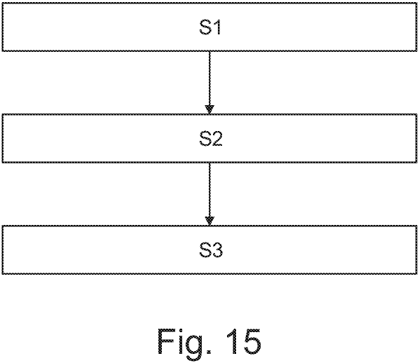

FIG. 15 a flowchart for a method for producing a filter unit.

FIGS. 1 to 6 show different views of a filter unit 100, which is configured for filtering a molten plastic. The filter unit 100 comprises a support body 102 with a hollow cylindrical wall section 104 and a base section 106 connected thereto. The support body 102 has a central longitudinal axis 108 and delimits an inner space 110. The hollow cylindrical wall section 104 has a plurality of through openings 112 opening into the inner space 110 and forms an outlet opening 114 for the molten plastic opposite the base section 106. The through openings 112 of the wall section 104 opening into the inner space 110 all have the same bore diameter 120. The through openings 112 are formed as through bores 112 in the present exemplary embodiment.

The base section 106 is arranged on the upstream side (right side of FIG. 1) of the support body 102 and the outlet opening 114 is arranged on the downstream side (left side of FIG. 1) of the support body 102. A filter element, such as a filter fleece, (not shown in FIGS. 1 to 6) is arranged around the wall section 104, for example pushed on. The molten plastic is pushed through the filter element and then passes through the through openings 112 into the inner space 110, in which the molten plastic then flows to the outlet opening and exits there again.

The ratio of the active filter area to the outer casing surface of the wall section 104 of the support body 102 is about 0.15 to 0.65, in particular about 0.25 to 0.5, in particular about 0.38. The active filter area is the total area of all through bores 112 or all cross-sectional areas 118 of the through bores 112. The active filter area can thus be calculated or defined by multiplying the number of through bores 112 with the cross-sectional area 118 of a through bore 122, as all through bores 112 have the same bore diameter 120.

The ratio of the wall thickness 122 of the wall section 104 of the support body 102 to a ratio of the diameter 124, such as outer diameter 124, of the wall section 104 of the support body 102, squared to the length 126 of the wall section 104 of the support body 102 in the direction of the central longitudinal axis 108 is about 0.1 to 0.6, in particular about 0.2 to 0.3, in particular about 0.25.

The filter unit 100 also comprises a displacement element 116 for displacing the molten plastic that has entered the inner space 110 via the through openings 112 substantially in the direction of the central longitudinal axis 108. As shown in FIGS. 5 and 6, the displacement element 116 and the support body 102 are formed in one piece and produced from one piece or part. A substantially non-weldable steel, in particular alloy steel, such as high-alloy, hot-work steel is used to produce the one-piece support body 102 with displacement element 116.

The displacement element 116 is arranged or formed in the inner space 110 and on the base section. As shown in FIG. 5, the displacement element 116 is substantially conical at least in sections, wherein the base surface of the displacement element 116 is formed by the base section 106. To allow an even flow of the molten plastic, the displacement element 116, as shown in FIGS. 2, 3 and 5, is arranged or formed concentrically to the central longitudinal axis 108.

The displacement element 116 further comprises a casing surface 128 or casing contour 128 with a plurality of casing surface sections 130a, 130b, 130c or casing contour sections 130a, 130b, 130c. The casing surface sections 130a, 130b, 130c or casing contour sections 130a, 130b, 130c taper substantially conically in the direction of the central longitudinal axis 108 and extend at different angles 132a, 132b, 132c obliquely and relative to the central longitudinal axis 108, wherein the angle of a radially outer casing surface section 130a, 130b, 130c or casing contour section 130a, 130b, 130c is greater than the angle of a radially inner casing surface section 130a, 130b, 130c or casing contour section 130a, 130b, 130c. In the present exemplary embodiment according to FIGS. 5 and 6 the radially outer casing surface section 130c or casing contour section 130c has a greater angle 132c relative to the central longitudinal axis 108 than the two radially further inner casing surface sections 130a, 130b or casing contour sections 130a, 130b. The radially inner casing surface section 130a or casing contour section 130a has a smaller angle 132a relative to the central longitudinal axis 108 than the two radially further outerlying casing surface sections 130b, 130c or casing contour sections 130b, 130c. In this way the casing surface or contour of the displacer element 116 is specifically adapted to enable an optimum flow and conveyance of the filtered molten plastic in the direction of the central longitudinal axis 108 to the outlet opening 114. The flow behaviour of the molten plastic and the rheological ratios can be optimally adjusted by selecting suitable angles 132a, 132b, 132c, in particular to prevent deposits of products on the inflow side. The capacity for chip removal during the production process can also be improved by a suitable selection of the angles 132a, 132b, 132c.

The support body 102 further comprises a holding section 134 on its downstream side, which is configured for attaching the filter unit 100 to a filter support. The holding section 134 can have an external thread complementary to a thread of the filter support for example (not shown in FIGS. 1 to 6), so that the support body 102 can be screwed to the filter support.

FIGS. 7 to 10 show various views of a filter arrangement 200, which is configured for filtering the molten plastic and is used in a filter changing device. The filter arrangement 200 has a filter support 202 with a support central longitudinal axis 204 and, as shown in FIG. 10, has a plurality of support through openings 206 extending in the direction of the support central longitudinal axis 204. In the region of the support through openings 206 a filter unit 100 is attached respectively detachably to the filter support 202, in particular screwed into an internal thread 208 by means of the holding section 134 of the filter unit 100. The filter units 100 are formed as described above and/or in the following. A filter element 210, for example filter fleece 210, is pushed respectively onto the support bodies 102 of the filter units 100 and fixed by means of a cover element 212 to the respective wall section 104 of the support body 102. The cover element 212 can be screwed to the support body 102, for example to its base section 106 and/or displacement element 116.

As shown in FIG. 9, the filter support 202 is circular in cross-section. The support central longitudinal axis 204 extends in the conveying direction and parallel to the central longitudinal axes 108 of the filter units 100, as shown in FIGS. 8 and 10. A first support through opening 206 is arranged concentrically to the support central longitudinal axis 204. A group of, here six, second support through openings 206 is arranged along a first circle concentric to the support central longitudinal axis 204, wherein the second support through openings 206 are arranged distributed evenly along the first circle. A further group of, here twelve, third support through openings 206 is arranged along a second circle concentric to the support central longitudinal axis 204, wherein the second circle surrounds the first circle. The third support through openings 206 are also distributed evenly along the second circle.

In addition, reference is also made in particular to FIGS. 1 to 6 and the associated description.

FIGS. 7 to 10 show different views of a filter changing device 300 for an extruder assembly. The filter changing device 300 comprises a housing 302 and two melt channels 304 extending in the housing 302, which open into or pass into a common inlet channel 306 or outlet channel 306 at the upstream melt inlet and at the downstream melt outlet respectively. The filter changing device 300 further comprises two guide bores 310, wherein each guide bore 310 extends transversely, for example substantially perpendicularly, to the respective melt channel 304 and through the latter into the housing 302. The guide bores 310 also extend transversely, for example substantially perpendicularly, to the conveying direction.

The filter changing device 300 has two cylindrical slide elements 312, wherein a slide element 312 is mounted displaceably in a guide bore 310 respectively. Furthermore, the filter changing device 300 comprises an actuating drive 314, which is configured to displace the slide elements 312 independently of one another transversely, for example substantially perpendicularly, to the conveying direction and transversely, for example substantially perpendicularly, to the respective melt channel 304. The at least one actuating drive 314 can be configured to be hydraulic and/or electromechanical for example.

In the present exemplary embodiment according to FIGS. 11 to 14, the filter changing device 300 comprises four filter arrangements 200. The filter arrangements 200 are configured as described above and/or in the following. Two filter arrangements 200 are arranged spaced apart from one another respectively on a slide element 312. For this purpose, two continuous receiving openings 316 are formed respectively in the slide elements 312, in each of which receiving opening a filter arrangement 200 is mounted and/or secured replaceably. The two receiving openings are spaced apart transversely, for example substantially perpendicularly, to the conveying direction and transversely, for example substantially perpendicularly, to the respective melt channel 304 such that one of the filter arrangements 200 is arranged outside the housing 302 when the respective other filter arrangement 200 is located in the melt channel 304.

In addition, reference is also made in particular to FIGS. 1 to 10 and the associated description.

FIG. 15 shows schematically a flowchart for a method for producing a filter unit 100.

In step S1 a blind hole is drilled and/or milled in an, in particular cylindrical, steel blank, for example a substantially non-weldable steel blank. The drilling and/or milling of the blind hole is performed along the central longitudinal axis 108.

In step S2 the blind hole is reamed, i.e. reamed out, for example with a reamer. The blind hole can be flushed out prior to the reaming.

In step S3 a displacement element 116 is drilled and/or milled inside the blind hole, in particular into the blind hole bottom or blind hole base. The drilling and/or milling of the displacement element 116 can be performed by using a drilling rod. The drilling rod can comprise a conical drill or can be configured in this way. The drilling rod can comprise at least one cutting plate, such as an indexable insert. The at least one cutting plate can have a geometry which is dependent on the surface and/or contour of the displacement element 116. The drilling rod can comprise a number of cutting plates, such as indexable inserts. The number of cutting plates can be dependent on the surface and/or contour of the displacement element 116. The number of cutting plates can be equal to or twice the number of surface sections or contour sections of the displacement element 116. For example, the drilling rod can comprise 1 to 10, in particular 2 to 7, in particular 3 to 5 cutting plates. There can be an even or odd number of cutting plates. The cutting plates can have and/or define the angle 132a, 132b, 132c of the surface sections or contour sections.

In addition, reference is also made in particular to FIGS. 1 to 14 and the associated description.

The term “can” is used in particular to refer to optional features of the disclosure. Thus, there are also further developments and/or exemplary embodiments of the disclosure, which, additionally or alternatively, have the respective feature or the respective features.

From the combinations of features disclosed herein, isolated features can also be selected if necessary and used in combination with other features to delimit the claimed subject-matter, while resolving any structural and/or functional relationship that may exist between the features. The sequence and/or number of steps of the method can be varied.

List of reference signs

| | |
|---|---|
| 100 | filter unit |
| 102 | support body |
| 104 | wall section |
| 106 | base section |
| 108 | central longitudinal axis |
| 110 | inner space |
| 112 | through openings |
| 114 | outlet opening |
| 116 | displacement element |
| 118 | cross-sectional areas |
| 120 | bore diameter |
| 122 | wall thickness |
| 124 | outer diameter |
| 126 | length |
| 128 | casing surface / casing contour |
| 130 a | casing surfaces sections / casing contour sections |
| 130 b | casing surface sections / casing contour sections |
| 130 c | casing surface sections / casing contour sections |
| 132 a | angle |
| 132 b | angle |
| 132 c | angle |
| 134 | holding section |
| 136 | external thread |
| 200 | filter arrangement |
| 202 | filter support |
| 204 | support central longitudinal axis |
| 206 | support through openings |
| 208 | inner thread |
| 210 | filter elements |
| 212 | cover elements |
| 300 | filter changing device |
| 302 | housing |
| 304 | melt channels |
| 306 | inlet channel |
| 308 | outlet channel |
| 310 | guide bore |
| 312 | slide elements |
| 314 | actuating drive |
| 316 | receiving openings |
| S1 | drilling and/or milling the blind hole |
| S2 | reaming the blind hole |
| S3 | drilling and/or milling the displacement element |

1. A filter unit for an extruder assembly, comprising:
a support body with a hollow cylindrical wall section and a base section connected thereto, wherein the support body has a central longitudinal axis and delimits an inner space, wherein the hollow cylindrical wall section has a plurality of through openings extending into the inner space and forms an outlet opening for a molten plastic opposite the base section; and
a displacement element for displacing the molten plastic which has entered the inner space, in particular via the through openings, substantially in the direction of the central longitudinal axis,
wherein the displacement element and the support body are configured and/or produced in one piece.

2. The filter unit according to claim 1, wherein the displacement element is arranged or configured in the inner space and/or on the base section.

3. The filter unit according to claim 1, wherein the displacement element is configured to be substantially conical and/or cone-shaped and/or partially cone-shaped and/or spherical and/or partially spherical at least in some sections, and/or wherein the base surface of the displacement element is formed and/or defined by the base section.

4. The filter unit according to claim 1, wherein the displacement element is arranged or configured to be concentric to the central longitudinal axis.

5. The filter unit according to claim 1, wherein the displacement element has a surface and/or contour, such as casing surface and/or casing contour, with one or more surface sections and/or contour sections, such as casing surface sections and/or casing contour sections, wherein the one or more surface sections or contour sections taper in the direction of the central longitudinal axis, in particular conically, and/or extend obliquely and/or relative to the central longitudinal axis, in particular at an angle.

6. The filter unit according to claim 5, wherein the plurality of surface sections or contour sections extend at different angles obliquely and/or relative to the central longitudinal axis, wherein the angle of a radially outer surface section or contour section is greater than the angle of a radially inner surface section or contour section.

7. The filter unit according to claim 1, wherein the through openings of the wall section opening into the inner space all have the same diameter.

8. The filter unit according to claim 1, wherein the support body and the displacement element are produced from a substantially non-weldable steel, in particular a hot work alloy steel such as a hot work high-alloy steel.

9. The filter unit according to claim 1, wherein the ratio of the active filter area to the casing surface of the support body, in particular of the wall section of the support body, is about 0.15 to 0.65.

10. The filter unit according to claim 1, wherein the ratio of the wall thickness of the support body, in particular of the wall section of the support body, to a ratio of diameter, such as outer diameter, of the support body, in particular of the wall section of the support body, squared to the length, in particular in the direction of the central longitudinal axis, of the support body, in particular of the wall section of the support body, is about 0.1 to 0.6.

11. A filter arrangement for an extruder assembly with a filter support, which has a support central longitudinal axis and a plurality of support through openings extending in the direction of the support central longitudinal axis, wherein in the region of each of the support through openings the filter unit according to claim 1 is attached and/or can be attached respectively in a detachable manner to the filter support.

12. A filter changing device for an extruder assembly, comprising:
a housing;
at least one melt channel extending in the housing;
at least one guide bore extending transversely to the at least one melt channel and through the latter in the housing;
at least one slide element arranged in the at least one guide bore; and
at least two filter arrangements according to claim 11 arranged and/or mounted spaced apart on the at least one slide element.

13. A method for producing the filter unit according to claim 1, comprising:
producing a blind hole in an, in particular cylindrical, steel blank, in particular substantially non-weldable steel blank; and
producing a displacement element inside the blind hole, in particular on or in the blind hole bottom or blind hole base.

14. The method according to claim 13, wherein the production of the blind hole and the displacement element is performed in one step or in consecutive steps.

15. The method according to claim 13, further comprising enlarging, in particular enlarging by machining, such as reaming, drilling or turning, the blind hole before and/or after producing the displacement element.

16. The method according to claim 13, wherein the production of the displacement element is performed by a drilling rod which has at least one cutting plate, such as an indexable insert, and/or wherein the at least one cutting plate has a geometry which is dependent on the surface and/or contour of the displacement element.

17. The method according to claim 16, wherein the drilling rod has a number of cutting plates, such as indexable inserts, which is dependent on the surface and/or contour of the displacement element and/or which corresponds to the number or twice the number of surface sections or contour sections of the displacement element, and/or in that the drilling rod has 1 to 10 cutting plates.
